(19) United States
(12) Patent Application Publication
(10) Pub. No.: US 2026/0362509 A1
(43) Pub. Date: Nov. 12, 2026

(54) MECHANISMS FOR HANDLING RADIO ACCESS TECHNOLOGY (RAT) TYPE, WHICH IS UNDEFINED WITHIN A MULTIMEDIA SUBSYSTEM, OVER POLICY CONTROL FUNCTION (PCF) NODE INTERFACE

(71) Applicant: DISH Wireless L.L.C., Englewood, CO (US)

(72) Inventors: Borong Zheng, Littleton, CO (US); Rajasubramanian Jambulingam, Highlands Ranch, CO (US); Ramakrishna Macharyulu Mudumby, Littleton, CO (US)

(21) Appl. No.: 19/200,481

(22) Filed: May 6, 2025

(51) Int. Cl. H04W 76/10; H04L 65/1016; H04L 65/1104; H04W 8/22; H04W 12/06

(52) U.S. Cl. CPC H04W 76/10; H04L 65/1016; H04L 65/1104; H04W 8/22; H04W 12/06

(57) ABSTRACT

A computing system to execute at least a portion of a wireless core network includes one or more processing devices to negotiate, by a policy control function (PCF) node, establishment of a wireless call session between a user equipment (UE) and a multimedia subsystem. The processing device receives, by the PCF node, a media authorization request from the multimedia subsystem. In response to detecting, by the PCF node within a UE context, that a radio access technology (RAT type) is undefined within the multimedia subsystem, the processing device converts the undefined RAT type to a new radio RAT type. The processing device can then include the new radio RAT type in a media authorization answer sent to the multimedia subsystem in response to the media authorization request.

### BACKGROUND

One type of cellular network is a Fifth Generation (5G) wireless network, although this disclosure may apply to other modern cellular networks, including 4G and 6G wireless networks. In a 5G wireless network, a 5G Core Network (5G core) is responsible for managing and routing data traffic, providing various network resources and services, and supporting the core functionalities of the cellular network. Fifth generation (5G) wireless networks have the promise to provide higher throughput, lower latency, and higher availability compared with previous global wireless standards. A combination of control and user plane separation (CUPS) and multi-access edge computing (MEC), which allows compute and storage resources to be moved from a centralized cloud location to the “edge” of a network and closer to end user devices and equipment, may enable low-latency applications with millisecond response times. A control plane (CP) may include a part of a network that controls how data packets are forwarded or routed. The control plane may be responsible for populating routing tables or forwarding tables to enable data plane functions. A data plane (or forwarding plane) may include a part of a network that forwards and routes data packets based on control plane logic.

The user plane function (UPF) nodes may be located within the core network and be configured to transport IP data traffic (e.g., user plane traffic) between user equipment (UE) and a data network and for handling protocol data unit (PDU) sessions with the data network. User plane function or UPF nodes may support the separation of control plane (CP) and user plane (UP) functions in the 5G architecture. This separation allows for independent scaling, flexibility, and deployment of the control and user plane functions.

The policy control function (PCF) node in the 5G core provides control-plane network function responsible for making policy decisions related to Quality of Service (QoS), access control, charging, mobility, and session management. The PCF node acts as the central control for policy enforcement in the 5G service-based architecture (SBA). During negotiation of a 5G session between a UE and another wireless device or system (e.g., another party), an Internet Protocol (IP) multimedia subsystem (IMS) processes the session establishment by invoking a receiving (Rx) authentication and authorization procedure between a proxy call session control function (P-CSCF) node of the IMS and the PCF node. If the IMS does not recognize the radio access technology (RAT) type of the UE, e.g., because the RAT type is not defined within the IMS, attempts to process such a RAT type by the IMS can lead to errors and undefined behaviors.

### BRIEF DESCRIPTION OF THE DRAWINGS

The present disclosure is illustrated by way of example, and not by way of limitation, in the figures of the accompanying drawings.

FIG. 1A is a block diagram a 5G network including a radio access network (RAN) and a core network according to various embodiments.

FIG. 1B-FIG. 1C are block diagrams of a radio access network and a core network for providing a communications channel (or channel) between a user equipment and a data network according to various embodiments.

FIG. 2A is a block diagram of an example architecture of a path through the 5G core network as part of a protocol data unit (PDU) session setup to connect a UE of to another device or system according to various embodiments.

FIG. 2B is the block diagram of FIG. 2A illustrating a media authorization request and response as between the IMS and the PCF node during a wireless call session setup according to various embodiments.

FIG. 3A is a flow diagram of a method for handling an IMS-undefined RAT type over an Rx (or N5) interface of the PCF node according to some embodiments.

FIG. 3B is a flow diagram of a method for handling an IMS-undefined RAT type over an Rx (or N5) interface of the PCF node according to additional embodiments.

FIG. 4 is a block diagram of some software functionality of the core network according to various embodiments.

### DETAILED DESCRIPTION

Technical mechanisms for handling an RAT type, which is undefined within a multimedia subsystem (or IMS), over a PCF node interface are described. The following description sets forth numerous specific details, such as examples of specific systems, components, methods, and so forth, in order to provide a good understanding of several aspects, embodiments, and implementations of the present disclosure. It will be apparent to one skilled in the art, however, that at least some aspects of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

A recent 3rd Generation Partnership Project (3GPP) release introduced a New Radio Reduced Capability (NR-REDCAP) to support Internet of Things (IoT) and industrial applications with lower complexity and power consumption. To identify NR-REDCAP UEs and devices, the 3 GPP has introduced a new RAT type, referred to as NR-REDCAP. When an NR-REDCAP device initiates a voice call using Voice over New Radio (VoNR), an IP multimedia subsystem (IMS) processes the IMS session establishment by invoking a receiving (Rx) authentication and authorization procedure between a proxy call session control function (P-CSCF) node of the IMS and the PCF node.

Because standards or vendors may have a gap in defining or supporting RAT types for the IMS, if the PCF node returns an authentication and authorization acknowledgment message (or response) that includes the RAT type as NR-REDCAP (or other IMS-undefined RAT type), the attempt by the IMS components to process the RAT type can lead to errors or undefined behaviors. Such errors can result in service disruptions, unpredictable network performance, or vendor-specific handling variations, increasing operational risks. While the present disclosure more particularly refers to NR-REDCAP RAT type, the present disclosure can be equally applied to other RAT types, which are undefined or unrecognized in the IMS, such as non-terrestrial network (NTN RATs), 5G NR unlicensed spectrum (NR-U), private 5G/non-public network (NPN) access, and interworking access types (e.g., Wi-Fi-5G convergence). Furthermore, the present disclosure may also apply to any future new RAT type that has a temporary standard gap or a vendor implementation gap, e.g., certain vendors have not yet added IMS platform support for the new RAT type.

Aspects of the present disclosure address the above and other deficiencies by employing mechanisms for handling, by the PCF mode, RAT types that are undefined within a multimedia subsystem (or IMS) so that the multimedia subsystem (or IMS) receives either a defined or recognized RAT type or no RAT type. For example, while negotiating to establish a wireless session between a UE having an IMS-undefined RAT type (such as NR-REDCAP) and targeted device or system on the 5G network, the PCF node can interact with a component of the multimedia subsystem to pass UE context parameter values to the multimedia subsystem. Thus, the PCF node can change or suppress the RAT type so that the RAT type is no longer undefined within the IMS.

In various embodiments, the PCF node receives a media authorization request from the multimedia subsystem that is intended to solicit UE context parameter values from the PCF node with which the multimedia subsystem can establish the wireless call session with the UE. In at least one embodiment, in response to detecting, by the PCF node within a UE context, that the RAT type is undefined within the multimedia subsystem, the PCF node converts the undefined RAT type to a new radio RAT type, or NR RAT type, and includes the new radio RAT type in a media authorization answer sent to the multimedia subsystem in response to the media authorization request. Because the multimedia subsystem understands (or recognizes) the defined NR RAT type, the multimedia subsystem can proceed with processing using the NR RAT type, avoiding any errors that may be generated by processing an undefined RAT type.

In at least another embodiment, in response to detecting, by the PCF node within a UE context, that the RAT type is undefined within the multimedia subsystem, the PCF node removes or suppresses the RAT type from a media authorization answer and sends the media authorization answer to the multimedia subsystem in response to the media authorization request. In embodiments, removing the RAT type from the media authorization answer includes excluding a RAT type value from a RAT type field of the media authorization answer. Because the RAT type is optional information to be sent from UE context to the multimedia subsystem, the multimedia subsystem can proceed with processing the session negotiation with a default or null RAT type. In this alternative approach, the multimedia subsystem likewise avoids any errors that may otherwise be generated by processing an IMS-undefined RAT type.

Some advantages of the present disclosure include preventing errors or undefined behaviors generated by the multimedia subsystem undergoing session negotiation processing with an IMS-undefined RAT type. Thus, service disruptions, unpredictable network performance, or vendor-specific handling variations, with concomitant increase in operational risks, can also be avoided. Additional advantages include eliminating IMS processing gaps for NR-REDCAP (or other IMS-undefined RAT type) devices and ensuring seamless voice service for users of NR-REDCAP (or other undefined RAT types) devices. Further, these advantages can be achieved without requiring changes to the IMS infrastructure. These and other advantages that would be apparent to those skilled in the art will be apparent from the following more detailed discussion.

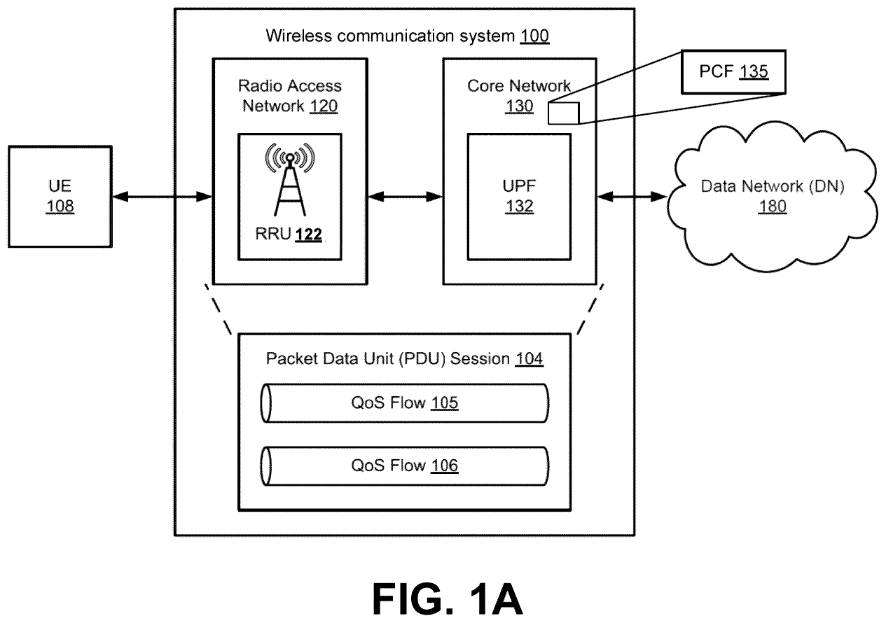

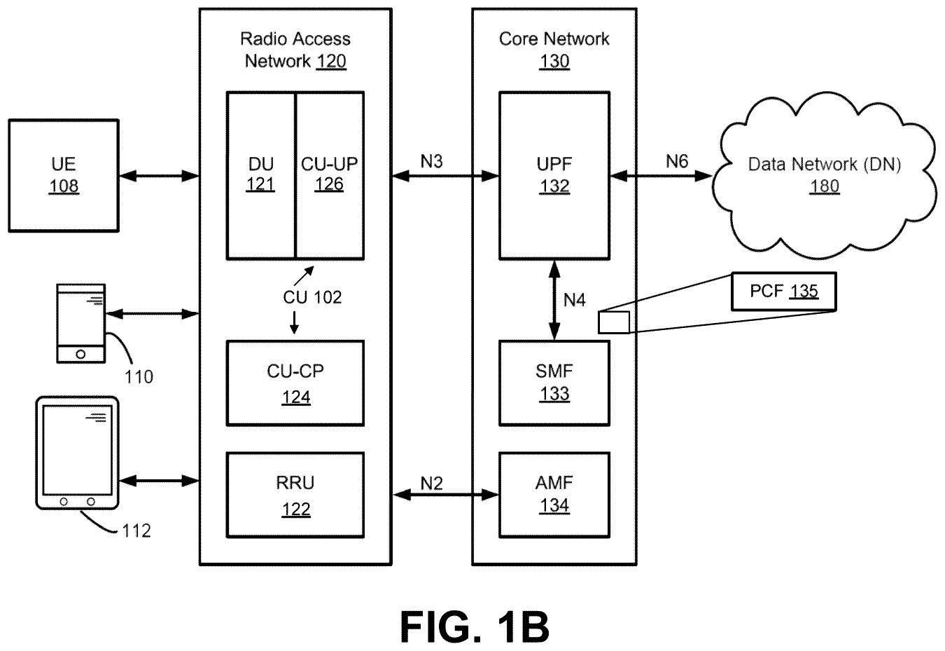

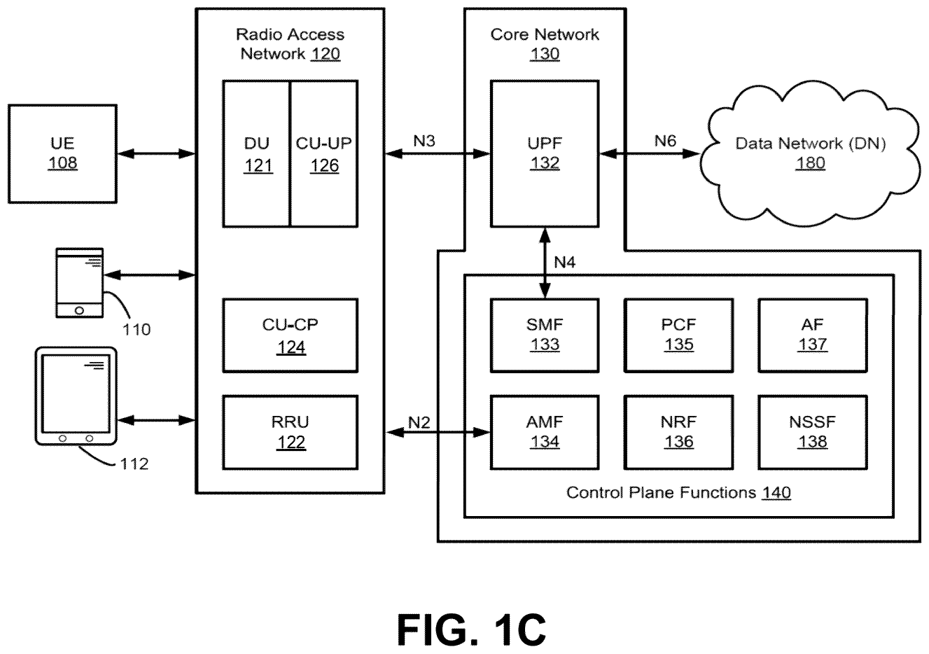

FIG. 1A is a block diagram of a wireless communication network 100 including a radio access network (RAN) 120 and a core network 130 according to various embodiments. The wireless communication network 100 may be, may include, or may be included in a 5G network. The RAN 120 can include a new-generation radio access network (NG-RAN) that uses the 5G new radio interface (NR). The wireless communication network 100 may connect a UE 108 to a data network 180 using the RAN 120 and the core network 130. The data network 180 can include the Internet, a local area network (LAN), a wide area network (WAN), a private data network, a wireless network, a wired network, or a combination of networks.

FIG. 1B is a block diagram of the RAN 120 and the core network 130 for providing a communications channel (or channel) between user equipment (e.g., UEs) and the data network 180 according to some embodiments. The communications channel can include a pathway through which data is communicated between a UE 108 and the data network 180. The user equipment in communication with the RAN 120 includes UE 108, mobile phone 110, and mobile computing device 112. The user equipment may include a set of electronic devices, including mobile computing device and non-mobile computing device.

In some embodiments, the UE 108 can include a 5G smartphone or a 5G cellular device that connects to the RAN 120 via a wireless connection. The UE 108 can include one of a number of UEs not depicted that are in communication with the RAN 120. The UEs may include mobile and non-mobile computing devices. The UEs may include laptop computers, desktop computers, an Internet-of-Things (IoT) devices, and/or any other electronic computing device that includes a wireless communications interface to access the RAN 120. With particular emphasis in the present disclosure, the UEs can be IoT devices or other similar devices with reduced capability and categorized a REDCAP.

With continued reference to FIGS. 1A-1B, in at least some embodiments, the RAN 120 includes one or more distributed units (DUs) 121 (FIG. 1B), a central unit (CU) 102, and a remote radio unit (RRU) 122 for wirelessly communicating with UE 108. In some aspects, the DU(s) 121 and the CU 102 of the RAN 120 may be co-located with the RRU 122. In other embodiments, the DU(s) 121, and the RRU 122 may be co-located at a cell site and the CU 102 may be located within a local data center (LDC) that is in close proximity to the cell site.

In embodiments, the split DU/CU architecture may provide flexibility, scalability, and efficiency in network deployment and operation. For example, each DU 121 may handle the real-time, lower-layer aspects of baseband processing, including the lower layer of the protocol stack, acting as intermediary between the CU 102 and the RRU 122. The DU 121 functionality may include physical layer (PHY) functions such as error correction, modulation/demodulation, and forward error correction (FEC). These DUs 121 may be responsible for dynamic radio resource management tasks, including scheduling of user data, allocation of radio resources, power control, and interference management, all towards optimizing the performance and efficiency of the radio access network.

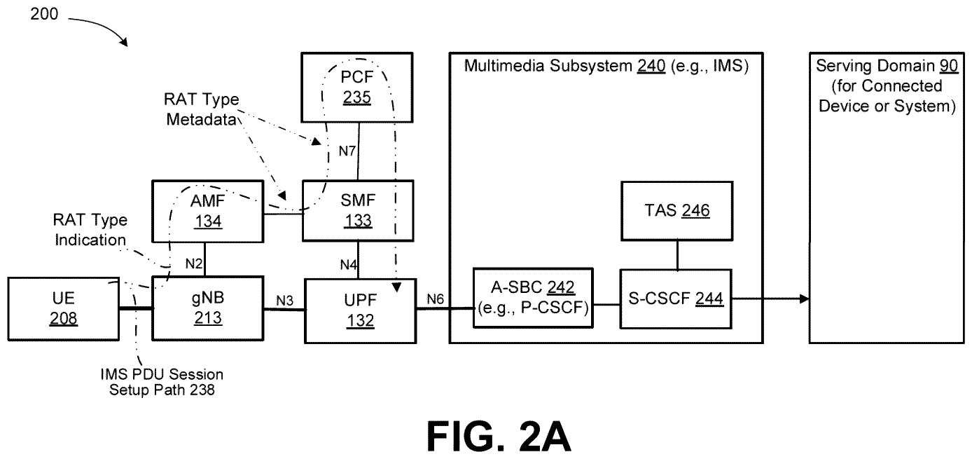

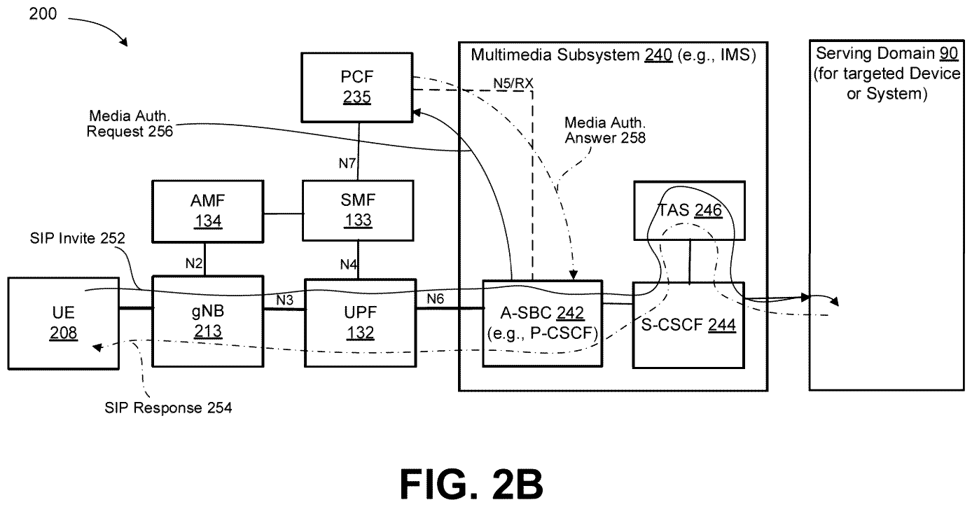

In at least some aspects, the CU 102 may communicate with the core network 130 and include a CU user plane (CU-UP) logical node and a CU control plane (CU-CP) logical node, as will be discussed in more detail with reference to FIGS. 2B-2C. The CU 102 may handle control plane functions of the RAN 120, managing signaling between the UE 108 and the core network 130. This includes session management, mobility management, and establishing bearers (data channels). Although the CU 102 is primarily focused on control plane functions, in some architectures, the CU 102 may also handle aspects of user plane processing, such as packet routing and forwarding, especially in architectures where the CU and DU functionalities are integrated to some extent. The CU 102 may also serve as the interface point to the 5G Core Network (5GC) through the N2 interface for control plane messages and the N3 interface for user plane data, depending on the architecture and deployment.

In various aspects, the CU 102 manages the mobility as users move across different cells or as they transition between different RAN technologies (e.g., from 5G NR to LTE). The CU 102 may be responsible for establishing, modifying, and releasing sessions and bearers for the UE 108, coordinating resources across the RAN 120 to ensure quality of service (QoS) requirements are met. The CU 102 may also play a role in executing security protocols for the RAN 120, including key management for encryption and integrity protection of the signaling and user data. With network slicing being a central feature of 5G, the CU 102 can manage the control plane aspects of network slices within the RAN 120, ensuring that slice-specific requirements for performance, latency, and reliability are met. In addition to interfacing with the core network, the CU 102 may also communicate with other RAN components, such as other CUs and DUs, for functions like load balancing, inter-cell handover, and dual connectivity.

The RRU 122 can include a Radio Unit (RU) and may include one or more radio transceivers for wirelessly communicating with UE 108. The RRU 122 may include circuitry for converting signals sent to and from an antenna of a Base Station into digital signals for transmission over packet networks. The RAN 120 may correspond with a 5G radio Base Station that connects user equipment to the core network 130. The 5G radio Base Station may be referred to as a generation Node B, a “gNodeB,” or a “gNB.” A Base Station may refer to a network element that is responsible for the transmission and reception of radio signals in one or more cells to or from user equipment, such as UE 108.

The core network 130 may utilize a cloud-native service-based architecture (SBA) in which different core network functions (e.g., authentication, security, session management, and core access and mobility functions) are virtualized and implemented as loosely coupled independent services that communicate with each other, for example, using HTTP protocols and APIs. In some cases, control plane (CP) functions 140 (FIG. 1C) may interact with each other using the service-based architecture. In at least one embodiment, a microservices-based architecture in which software is composed of small independent services that communicate over well-defined APIs may be used for implementing some of the core network functions. For example, CP network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the SBA.

The primary core network functions can include the access and mobility management function (AMF) node, the session management function (SMF) node, and a user plane function (UPF) node, all of which may provide user session capability and user data. The UPF node 132 may perform packet processing including routing and forwarding, quality of service (QoS) handling, and protocol data unit (PDU) session management. The UPF node 132 may serve as an ingress and egress point for user plane traffic and provide anchored mobility support for user equipment. For example, the UPF node 132 may provide an anchor point between the UE 108 and the data network 180 as the UE 108 moves between coverage areas. The AMF node may act as a single-entry point for a UE connection and perform mobility management, registration management, and connection management between a data network and UE. The SMF node may perform session management, user plane selection, and IP address allocation.

Other core network functions may include a network repository function (NRF) for maintaining a list of available network functions and providing network function service registration and discovery, the policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and a policy control function, or PCF node 135 (e.g., bandwidth requirements for QoS). In some cases, when user equipment requests access to resources, such as establishing a PDU session or a QoS flow, the PCF node 135 may dynamically decide if the user equipment should grant the requested access based on a location of the user equipment.

A network slice can include an independent end-to-end logical communications network that includes a set of logically separated virtual network functions. Network slicing may allow different logical networks or network slices to be implemented using the same compute and storage infrastructure. Therefore, network slicing may allow heterogeneous services to coexist within the same network architecture via allocation of network computing, storage, and communication resources among active services. In some cases, the network slices may be dynamically created and adjusted over time based on network requirements. For example, some networks may require ultra-low-latency or ultra-reliable services. To meet ultra-low-latency requirements, components of the RAN 120, such as the DUs 121 and the CU 101, may need to be deployed at a cell site or in an LDC that is in close proximity to a cell site such that the latency requirements are satisfied.

The wireless communication network 100 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a 5G network, such as an instantiation of the wireless communication network 100. In some cases, the wireless communication network 100 may support customized policy configuration and enforcement between network slices per service level agreements (SLAs) within the RAN 120. User equipment, such as UE 108, may connect to multiple network slices at the same time (e.g., eight different network slices). In one embodiment, a PDU session, such as PDU session 104, may belong to only one network slice instance. In some cases, the wireless communication network 100 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents.

The core network 130 may include a set of network elements that are configured to offer various data and telecommunications services to subscribers or end users of user equipment, such as UE 108. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

Virtualization allows virtual hardware to be created and decoupled from the underlying physical hardware. One example of a virtualized component is a virtual router (or a vRouter). Another example of a virtualized component is a virtual machine (VM). A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64 GB virtual disk) for the virtual machine. Another example of a virtualized component is a software container or an application container that encapsulates an application's environment.

In some aspects, applications and services may be run using virtual machines instead of containers in order to improve security. A common virtual machine may also be used to run applications and/or containers for a number of closely related network services.

The wireless communication network 100 may implement various network functions, such as the core network functions and radio access network functions, using a cloud-based compute and storage infrastructure. A network function may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

As depicted in FIGS. 1A-1B, the core network 130 includes a user plane function (UPF) node 132 for transporting IP data traffic (e.g., user plane traffic) between the UE 108 and the data network 180 and for handling PDU sessions with the data network 180. The UPF node 132 can include an anchor point between the UE 108 and the data network 180. The UPF node 132 may be implemented as a software process or application running within a virtualized infrastructure or a cloud-based compute and storage infrastructure. The wireless communication network 100 may connect the UE 108 to the data network 180 using a PDU session 104 (or wireless session), which can include part of an overlay network for example.

The PDU session 104 may utilize one or more quality of service (QoS) flows, such as QoS flows 105 and 106, to exchange traffic (e.g., data and voice traffic) between the UE 108 and the data network 180. The one or more QoS flows can include the finest granularity of QoS differentiation within the PDU session 104. The PDU session 104 may belong to a network slice instance through the wireless communication network 100. To establish user plane connectivity from the UE 108 to the data network 180, an AMF node that supports the network slice instance may be selected and a PDU session via the network slice instance may be established. In some cases, the PDU session 104 may be of type Ipv4 or Ipv6 for transporting IP packets. The RAN 120 may be configured to establish and release parts of the PDU session 104 that cross the radio interface.

The RAN 120 may include a set of one or more RRUs that includes radio transceivers (or combinations of radio transmitters and receivers) for wirelessly communicating with UEs. The set of RRUs may correspond with a network of cells (or coverage areas) that provide continuous or nearly continuous overlapping service to UEs, such as UE 108, over a geographic area. Some cells may correspond with stationary coverage areas and other cells may correspond with coverage areas that change over time (e.g., due to movement of a mobile RRU).

In some cases, the UE 108 may be capable of transmitting signals to and receiving signals from one or more RRUs within the network of cells over time. One or more cells may correspond with a cell site. The cells within the network of cells may be configured to facilitate communication between UE 108 and other UEs and/or between UE 108 and a data network, such as the data network 180. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

In embodiments, the UPF node 132 is responsible for routing and forwarding user plane packets between the RAN 120 and the data network 180. Uplink packets arriving from the CU-UP of the RAN 120 may use a general packet radio service (GPRS) tunneling protocol (or GTP) to reach the UPF node 132. The GPRS tunneling protocol for the user plane (GTP-U) may support multiplexing of traffic from different PDU sessions by tunneling user data over the interface between the RAN 120 and the UPF node 132.

The UPF node 132 may remove the packet headers belonging to the GTP tunnel before forwarding the user plane packets towards the data network 180. As the UPF node 132 may provide connectivity towards other data networks in addition to the data network 180, the UPF node 132 ensures that the user plane packets are forwarded towards the correct data network. Each GTP tunnel may belong to a specific PDU session, such as PDU session 104. Each PDU session may be set up towards a specific data network name (DNN) that uniquely identifies the data network to which the user plane packets should be forwarded. The UPF node 132 may keep a record of the mapping between the GTP tunnel, the PDU session, and the DNN for the data network to which the user plane packets are directed.

Downlink packets arriving from the data network 180 are mapped onto a specific QoS flow belonging to a specific PDU session before forwarded towards the appropriate RAN 120. A QoS flow may correspond with a stream of data packets that have equal quality of service (QoS). A PDU session may have multiple QoS flows, such as the QoS flows 105 and 106 that belong to PDU session 104. The UPF node 132 may use a set of service data flow (SDF) templates to map each downlink packet onto a specific QoS flow. The UPF node 132 may receive the set of SDF templates from a session management function (SMF), such as the SMF node 133 depicted in FIG. 1B, during setup of the PDU session 104. The SMF node 133 may generate the set of SDF templates using information provided from a policy control function (PCF), such as the PCF node 135. The UPF node 132 may track various statistics regarding the volume of data transferred by each PDU session, such as PDU session 104, and provide the information to an SMF node 133.

The core network 130 can include network functions such as an access and mobility management function (AMF) node 134, a session management function (SMF) node 133, and a user plane function (UPF) node 132. The AMF node 134 may interface with user equipment and act as a single-entry point for a UE connection. The AMF node 134 may interface with the SMF node 133 to track user sessions, to include authenticate the UE 108, assign the UE 108 an IP address, and create a session for the UE 108. The AMF 134 may interface with a network slice selection function (NSSF) (not depicted) to select network slice instances for user equipment, such as UE 108. When a UE is leaving a first coverage area and entering a second coverage area, the AMF node 134 may be responsible for coordinating the handoff between the coverage areas whether the coverage areas are associated with the same radio access network or different radio access networks. The SMF node 133 may also manage security of the UE 108 and ensure that user data is protected.

The UPF node 132 may transfer downlink data received from the data network 180 to user equipment, such as UE 108, via the RAN 120 and/or transfer uplink data received from user equipment to the data network 180 via the RAN 120. An uplink can include a radio link though which user equipment transmits data and/or control signals to the RAN 120. A downlink can include a radio link through which the RAN 120 transmits data and/or control signals to the user equipment. The UPF node 132 may thus be responsible for functions such as packet routing, packet forwarding, and packet filtering.

The RAN 120 may be logically divided into a remote radio unit (RRU) 122, the DU 121, and CU 102 that is partitioned into a CU-UP logical node 126 and a CU-CP logical node 124. The CU-UP logical node 126 may correspond with the CU 102 for the user plane and the CU-CP logical node 124 may correspond with the CU 102 for the control plane. The CU-CP logical node 124 may perform functions related to a control plane, such as connection setup, mobility, and security. The CU-UP logical node 126 may perform functions related to a user plane, such as user data transmission and reception functions.

Decoupling control signaling in the control plane from user plane traffic in the user plane may allow the UPF node 132 to be positioned in close proximity to the edge of a network compared with the AMF node 134. As a closer geographic or topographic proximity may reduce the electrical distance, this means that the electrical distance from the UPF node 132 to the UE 108 may be less than the electrical distance of the AMF node 134 to the UE 108. The RAN 120 may be connected to the AMF node 134, which may allocate temporary unique identifiers, determine tracking areas, and select appropriate PCFs for user equipment via an N2 Interface. The N3 Interface may be used for transferring user data (e.g., user plane traffic) from the RAN 120 to the user plane function UPF node 132 and may be used for providing low-latency services using edge computing resources. The electrical distance from the UPF node 132 (e.g., located at the edge of a network) to user equipment, such as UE 108, may impact the latency and performance services provided to the user equipment. The UE 108 may be connected to the SMF node 133 via an N1 interface (not depicted), which may transfer UE information directly to the AMF node 134. The UPF node 132 may be connected to the data network 180 via an N6 interface. The N6 interface may be used for providing connectivity between the UPF node 132 and other external or internal data networks (e.g., to the Internet). The RAN 120 may be connected to the SMF node 133, which may manage UE context and network handovers between Base Stations, via the N2 interface. The N2 interface may be used for transferring control plane signaling between the RAN 120 and the AMF node 134.

The RRU 122 may perform physical layer functions, such as employing orthogonal frequency-division multiplexing (OFDM) for downlink data transmission. In some cases, the DU 121 may be located at a cell site (or a cellular Base Station) and may provide real-time support for lower layers of the protocol stack, such as the radio link control (RLC) layer and the medium access control (MAC) layer. The CU 102 may provide support for higher layers of the protocol stack, such as the service data adaptation protocol (SDAP) layer, the packet data convergence control (PDCP) layer, and the radio resource control (RRC) layer. The SDAP layer can include the highest L2 sublayer in the 5G NR protocol stack. In some aspects, a radio access network may correspond with a single CU that connects to multiple DUs 121 (e.g., 10 DUs), and each DU may connect to multiple RRUs (e.g., 18 RRUs). In this case, a single CU may manage 10 different cell sites (or cellular Base Stations) and 180 different RRUs.

In some aspects, the RAN 120 or portions of the RAN 120 may be implemented using multi-access edge computing (MEC) that allows computing and storage resources to be moved closer to user equipment. Allowing data to be processed and stored at the edge of a network that is located close to the user equipment may be necessary to satisfy low-latency application requirements. In at least one example, the DU 121 and CU-UP 126 may be executed as virtual instances within a data center environment that provides single-digit millisecond latencies (e.g., less than 2 ms) from the virtual instances to the UE 108.

Aspects described herein may use containerization to implement such microservices. Containerization is the packaging of software code with just the operating system (OS) libraries and dependencies required to run the code to create a single lightweight executable (a container) that runs consistently on any infrastructure. Software platforms, such as Kubernetes, manage containerized workloads and automate the deployment, scaling, and management of containerized applications. Compared to virtual machines (VMs) containers have relaxed isolation properties to share the OS among the applications. Therefore, containers are considered lightweight. A container has its own file system, share of CPU, memory, and process space. As they are decoupled from the underlying infrastructure and are portable across clouds and OS distributions.

A cluster is made up of nodes that run containerized applications. Each cluster also has a master (control plane) that manages the nodes and pods of the cluster. A node represents a single machine in a cluster, typically either a physical machine or virtual machine that is located either on-premises or hosted by a cloud service provider. Each node hosts groups of one or more containers (which run applications), and the master communicates with nodes about when to create or destroy containers and how to re-route traffic based on new container alignments. The Kubernetes master is the access point (or the control plane) from which administrators and other users interact with the cluster to manage the scheduling and deployment of containers.

A pod is the basic unit of scheduling for applications running on a cluster. The applications are running in containers, and each pod includes one or more container(s). While pods are able to house multiple containers, one-container-per-pod may also be used. In some situations, containers that are tightly coupled and need to share resources may sit in the same pod. Pods can quickly and easily communicate with one another as if they were running on the same machine. They do still, however, maintain a degree of isolation. Each pod is assigned a unique IP address within the cluster, allowing the application to use ports without conflict.

When a pod gets created, the pod is scheduled to run on a node. The pod remains on that node until the process is terminated, the pod object is deleted, the pod is evicted for lack of resources, or the node fails. In Kubernetes, pods are the unit of replication. If an application becomes overly popular and a pod can no longer facilitate the load, Kubernetes can deploy replicas of the pod to the cluster.

Software container orchestration platforms, such as Amazon® Elastic Kubernetes Service (Amazon EKS), are services for users to run Kubernetes on the cloud of a cloud computing service provider, such as Amazon® Web Services (AWS®), without the user needing to install, operate, and maintain their own Kubernetes control plane or nodes. An Amazon EKS cluster comprises of two primary components: the Amazon® EKS control plane and Amazon EKS nodes that are registered with the control plane. The Amazon® EKS control plane comprises of control plane nodes that run the Kubernetes software and the Kubernetes application programming interface (API) server. The control plane may run in an account managed by AWS® or the telecommunication service provider, and the Kubernetes API is exposed via the Amazon® EKS endpoint associated with the cluster. Each Amazon® EKS cluster control plane is single-tenant and unique, and runs on its own set of Amazon® Elastic Compute Cloud (EC2) instances, which provide scalable computing capacity in the AWS® cloud.

However, other types of cloud compute instances or virtual machine instances may be used on various other cloud computing provider service platforms. The cluster control plane may be provisioned across multiple Availability Zones (aZs) and fronted by an Elastic Load Balancing Network Load Balancer. Amazon® EKS may also provision elastic network interfaces in VPC subnets to provide connectivity from the control plane instances to the nodes. Amazon® EKS nodes may run in an AWS account of the telecommunication service provider and connects to the telecommunication service provider's cluster control plane via the API server endpoint and a certificate file that is created for the cluster.

As disclosed herein, network functions (NFs) of the 5G NR cellular telecommunication network implemented in respective node groups are useful mechanisms for creating pools of resources in the 5G network that can enforce scheduling requirements. These NFs also provide a utility for shifting workloads around in the 5G network during cluster management and updates. Such NFs of the 5G NR cellular telecommunication network may be hosted on a cloud service provider cloud and referred to herein as cloud-native network functions (CNFs).

In some aspects, the CU-UP logical node 126 and/or the CU-CP logical node 124 are executed as pods, e.g., one or more of a CU-UP pod and a CU-CP pod running on a first cloud compute instance within a node group of a cluster being hosted on a first cloud compute instance. In other aspects, the CU-UP logical node 126 and/or the CU-CP logical node 124 are containers, nodes, logical units, or circuits configured to execute firmware and/or software to implement functionality of CU-UP and CU-CP logical nodes, respectively.

FIG. 1C depicts a RAN 120 and a core network 130 for providing a communications channel (or channel) between user equipment (UE) and the data network 180 according to at least one embodiment. The core network 130 includes the UPF node 132 for handling user data in the core network 130. Data is transported between the RAN 120 and the core network 130 via the N3 Interface. The data may be tunneled across the N3 Interface (e.g., IP routing may be done on the tunnel header IP address instead of using end user IP addresses). This may allow for maintaining a stable IP anchor point even though the UE 108 may be moving around a network of cells or moving from one coverage area into another coverage area. The UPF node 132 may connect to external data networks, such as the data network 180 via the N6 interface. The data may not be tunneled across the N6 interface as IP packets may be routed based on end user IP addresses. The UPF node 132 may connect to the SMF node 133 via the N4 interface.

In some aspects, the N3 interface is configured to transfer user plane data (i.e., the actual data traffic like voice, video, internet data, etc.) between the gNB (e.g., the CU-UP logical node 126 of the RAN 120) and the UPF node 132. The CU-UP logical node 126 may employ the GPRS Tunneling Protocol for the User plane (GTP-U) over the N3 interface for data packet encapsulation and tunneling. The N3 interface can support the segmentation and reassembly of user plane PDUs. The N3 interface provides mechanisms for path management, which includes establishing, modifying, and releasing GTP-U tunnels, e.g., by the CU-UP logical node 126. The 5G architecture allows for flexible deployment options, and thus the physical distance between gNB and UPF node can vary based on the deployment. For example, in edge computing scenarios, the UPF node 132 might be located closer to the RAN 120 (and hence the gNB) to reduce latency. Conversely, in other scenarios, the UPF node 132 might be more centralized, leading to a longer N3 interface in terms of physical distance.

As depicted, the core network 130 includes a group of control plane functions 140 including SMF node 133, AMF node 134, PCF node 135, NRF 136, AF 137, and NSSF 138. The SMF node 133 may configure or control the UPF node 132 via the N4 interface. For example, the SMF node 133 may control packet forwarding rules used by the UPF node 132 and adjust QoS parameters for QoS enforcement of data flows (e.g., limiting available data rates). In some cases, multiple SMF/UPF pairs may be used to simultaneously manage user plane traffic for a particular user device, such as UE 108. For example, a set of SMF nodes may be associated with UE 108, where each SMF node of the set of SMF nodes corresponds with a network slice. The SMF node 133 may control the UPF node 132 on a per end user data session basis, in which the SMF node 133 may create, update, and remove session information in the UPF node 132.

In some cases, the SMF node 133 may select an appropriate UPF node for a user plane path by querying the NRF 136 to identify a list of available UPF nodes and their corresponding capabilities and locations. The SMF node 133 may select the UPF node 132 based on a physical location of the UE 108 and a physical location of the UPF node 132 (e.g., corresponding with a physical location of a data center in which the UPF node 132 is running). The SMF node 133 may also select the UPF node 132 based on a particular network slice supported by the UPF node 132 or based on a particular data network that is connected to the UPF node 132. The ability to query the NRF node 136 for UPF information eliminates the need for the SMF node 133 to store and update the UPF information for every available UPF node within the core network 130.

In some aspects, the SMF node 133 may query the NRF 136 to identify a set of available UPF nodes 132 for a protocol data unit (PDU) session and acquire UPF information from a variety of sources, such as the AMF node 134 or the UE 108. The UPF information may include a location of the UPF node 132, a location of the UE 108, the UPF's dynamic load, the UPF node's static capacity among UPFs supporting the same data network, and the capability of the UPF node 132.

The RAN 120 may provide separation of the centralized unit for the CU-CP logical node 124 and the CU-UP 126 functionalities while supporting network slicing. The CU-CP logical node 124 may obtain resource utilization and latency information from the DU 121 and/or the CU-UP logical node 126 and select a CU-UP logical node 126 to pair with the DU 121 based on the resource utilization and latency information in order to configure a network slice. Network slice configuration information associated with the network slice may be provided to the UE 108 for purposes of initiating communication with the UPF 132 using the network slice.

FIG. 2A is a block diagram of an example architecture 200 of a path through the 5G core network 130 as part of a protocol data unit (PDU) session setup to connect a UE 208 to another device or system according to various embodiments. The example architecture 200 includes a multimedia subsystem 240 such as IMS that includes an access session border controller (A-SBC) node 242, an example of which is a proxy call session control function (P-CSCF) node, and a serving CSCF or S-CSCF node 244 that serves communications back and forth between a serving domain 90 and the A-SBC node 242.

In embodiments, the 5G core network 130 sets up an IMS PDU session, over an IMS PDU session setup path 238, that provides Internet Protocol Connectivity Access Network (IP-CAN) to the A-SBC node 242. IP-CAN may refer to the network segment that provides IP connectivity to the UE 208 and forms the access layer that enables devices to read IP-based services like internet, IMS (for VoIP), or enterprise networks. Thus, this IP connectivity (IP-CAN) is first established before a wireless call session can be established on top of the IMS PDU session, as will be discussed with reference to FIG. 2B.

In embodiments, the IMS PDU session setup path 238 flows through a base station (or gNB) 213 and to the AMF node 134 over the N2 interface. The indication of RAT type (such as the NR-REDCAP) of the UE 208 also passes over the N2 interface and flows, formally as a RAT type to the SMF node 133 and to a PCF node 235, e.g., over the N7 interface. In some embodiments, the PCF node 235 is the PCF node 135 of FIGS. 1A-1C. The PCF node 235 can store, as part of a UE context of the UE 208, an IMS-undefined RAT type (such as NR-REDCAP) conveyed through the AMF node 134 and the SMF node 133 to the PCF node 235. Ultimately, the IMS PDU session setup path 238 also goes through the UPF node 132 over the N4 interface and into the multimedia subsystem 240 over the N6 interface. For example, the SMF node 133 can establish an N4 session with the UPF node 132 that sets up a media path from the UE 208 to the gNB 213, from the gNB 213 to the UPF node 132 over the N3 interface, and to the A-SBC node 242 over the N6 interface, as illustrated in FIG. 2B.

FIG. 2B is the block diagram of FIG. 2A illustrating a media authorization request and response as between the IMS and the PCF node 235 during a wireless call session setup according to various embodiments. In some embodiments, as an extension of the discussion of FIG. 2A, the UE 208 has a RAT type of NR-REDCAP (new radio, reduced capability) that would characterize an IoT device, for example, or other IMS-undefined RAT type as were previously discussed. In some embodiments, the multimedia subsystem 240 processes establishment of a wireless call session (e.g., for an IMS session initiation protocol (SIP) session) by invoking the Rx authentication and authorization procedure between the P-CSCF node (or more generally, any A-SBC node 242) and the PCF node 235.

In some embodiments, the wireless call (or IMS SIP) session establishment path begins with the UE 208 starting a VoNR call with a session initiation protocol (SIP) invite 252 having an session description protocol (SDP) offer. The call can be delivered over an IMS PDU session bearer to the multimedia subsystem 240 (such as IMS), which follows standard IMS routing procedures and forwards the call to the serving domain 90 of the other party, such as a target device or system.

In embodiments, the multimedia subsystem 240 mediates the wireless call (or IMS SIP) session setup with the serving domain 90 for a targeted device or system with which the wireless call session has been requested. The RAT type is typically conveyed via the P-Access-Network-Info (P-ANI) header or 3 GPP Access-Network-Info attribute value pair (AVP) in diameter-based IMS signaling. For 5G new radio, the RAT type is usually labeled as “NR.”

In some embodiments, the serving domain 90 returns a SIP response 254 with a SDP answer. The SIP response 254 could be a provisional 18X response or a final SIP response. Upon receiving the SDP answer or SDP offer in case of QoS preconditioning is requested, the A-SBC node 242 (e.g., P-CSCF node) serving the UE 208 can initiate an IP-CAN media authorization procedure with the PCF node 235. In some deployments, such media authorization procedure can be fronted with a 3GPP binding serving function (BSF). The purpose of BSF is to serve as a proxy between the PCF node 235 and the P-CSCF node to ensure the same PCF node is selected that is serving the underlining IP-CAN from the IMS PDU session.

In some embodiments, the PCF node 235 applies different QoS policies or IMS profiles based on the UE category, which could be inferred from capability exchanges or subscription profiles. As discussed with reference to FIG. 2A, as part of the UE context, the PCF node 235 might store an undefined RAT type (such as NR-REDCAP) conveyed through the AMF node 134 and the SMF node 133 to the PCF node 235. Further, depending on generation of technologies of the core network 130, the interface between PCF node 235 and the A-SBC node 242 (e.g., P-CSCF node) can be 5G-based hypertext transfer protocol (HTTP)/2 N5 interface (as per 3GPP 29.514) or Fourth Generation (4G)-based Diameter Rx interface (as per 3GPP 29.214). In embodiments, the N5 interface interacts with application function (AF) node(s) for services like IMS/VoNR or video over NR (ViNR).

For 4G Rx interface, the P-CSCF node can send a diameter authentication and authorization request to the PCF node 235, with “Specific-Action” AVP requesting notification of IP-CAN type from the PCF node 235. In embodiments, the PCF node 235 returns a diameter authentication and authorization answer to the P-CSCF node, including the “RAT-Type” AVP, which can be stored with value of NR-REDCAP as result of prior IMS PDU session setup. For 5G N5 interface, the P-CSCF node may create an application session context in the PCF node 235, and then invoke NPCF_Policy_Authorization_Subscribe service operation with subscription to event “ACCESS_TYPE_CHANGE” towards the application session context. In embodiments, the PCF node 235 returns the stored RAT type as NR-REDCAP (or other IMS-undefined RAT type) to the P-CSCF node in the returned NPCF_Policy_Authorization_Notify service operation. As previously discussed, because the RAT type (such as NR-REDCAP) may have a standard or vendor support gap, this can result in service disruptions, unpredictable network performance, or vendor-specific handling variations, increasing operational risks in the IMS domain, e.g., in the multimedia subsystem 240.

According to various embodiments, therefore, in performing a media authorization procedure, the A-SBC node 242 of the multimedia subsystem 240 sends a media authorization request 256 of varying format (depending on generation of technology) to the PCF node 235, as was just discussed. The PCF node 235 can then respond with a media authorization answer 258 that includes a number of UE context values that the PCF node 235 has stored locally, such as subscription permanent identifier (SUPI) and RAT type to name a couple.

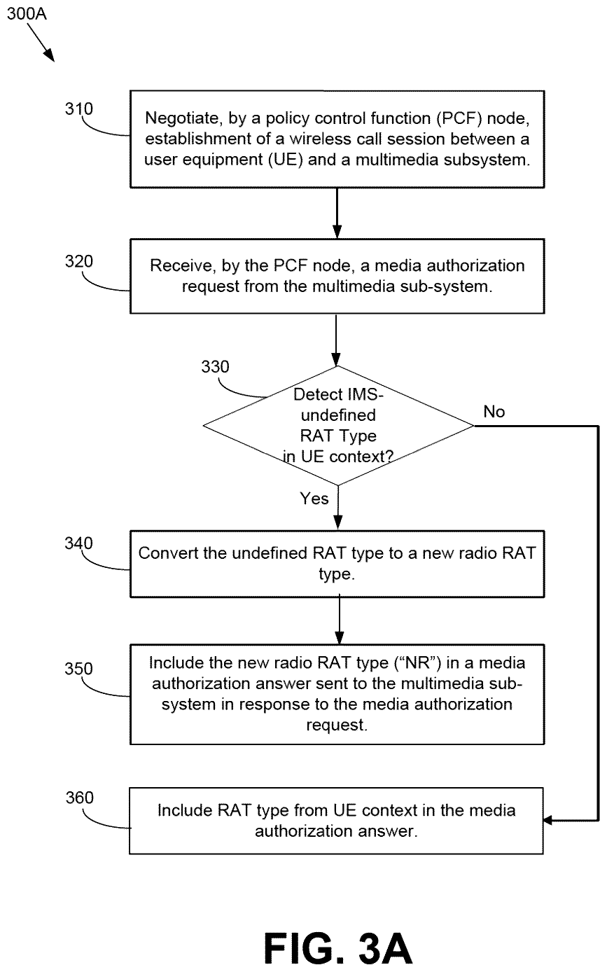

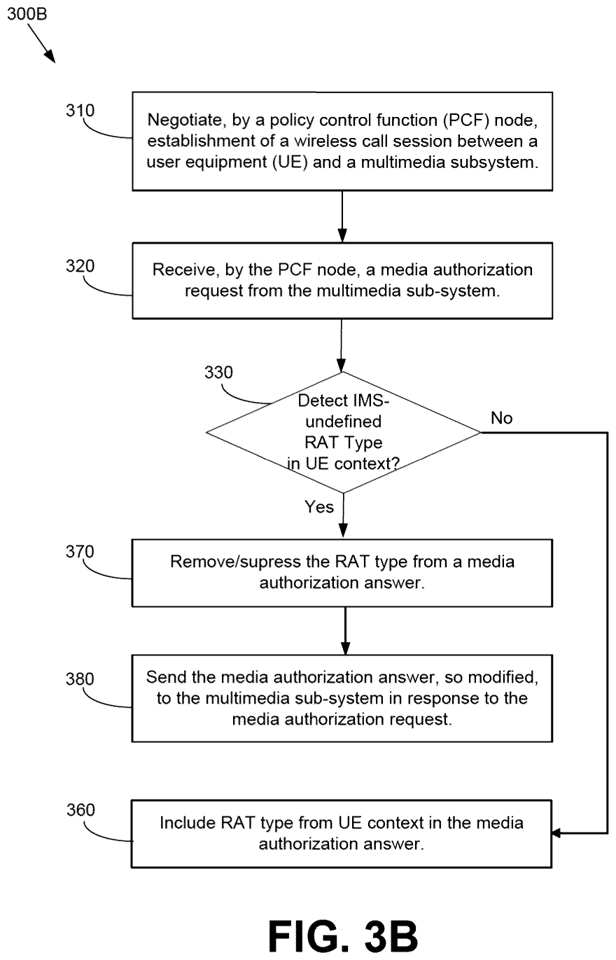

As discussed in more detail with reference to FIG. 3A, in at least one embodiment, the PCF node 235 is configured to convert the IMS-undefined RAT type (e.g., NR-REDCAP) to a new radio RAT type (“NR”), which is an existing RAT type, and include the new radio RAT type in the media authorization answer 258 sent to the multimedia subsystem 240 in response to the media authorization request 256. As discussed in more detail with reference to FIG. 3B, in at least an alternative embodiment, the PCF node 235 is configured to remove the RAT type (e.g., NR-REDCAP) from the media authorization answer 258 and send the media authorization answer 258 to the multimedia subsystem 240 in response to the media authorization request 256.

FIG. 3A is a flow diagram of a method 300A for handling an IMS-undefined RAT type over an Rx interface of the PCF node according to some embodiments. The method 300A may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 300A is performed by the core network 130 FIGS. 1A-2B. In various embodiments, the method 300A is performed by the PCF node 135 or 235. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

At operation 310, the processing logic (e.g., of the PCF node 135 or 325) negotiates establishment of a wireless call session between the UE 208 and the multimedia subsystem 240. In some embodiments, a RAT type is an NR-REDCAP RAT type that is undefined within the multimedia subsystem 240 (or IMS). In other embodiments, the RAT type is non-terrestrial network (NTN RATs), 5G NR unlicensed spectrum (NR-U), private 5G/non-public network (NPN) access, or interworking access types (e.g., Wi-Fi-5G convergence), which may also not be defined within or recognized by the multimedia subsystem 240.

In embodiments, before negotiating establishment of the wireless call session, the 5G core network may establish a PDU session for the UE, which can itself include receiving, from an SMF node, a RAT type such as NR-REDCAP (or other RAT type not recognized by the multimedia subsystem 240) during session setup. The processing logic can store the IMS-undefined RAT type within the PCF node 135 or 235. Then, during setting up the wireless call (or SIP) session, the processing logic can retrieve, in response to the media authorization request 256, the RAT type as one of a plurality of parameters of the UE context.

At operation 320, the processing logic receives the media authorization request 256 from the multimedia subsystem 240.

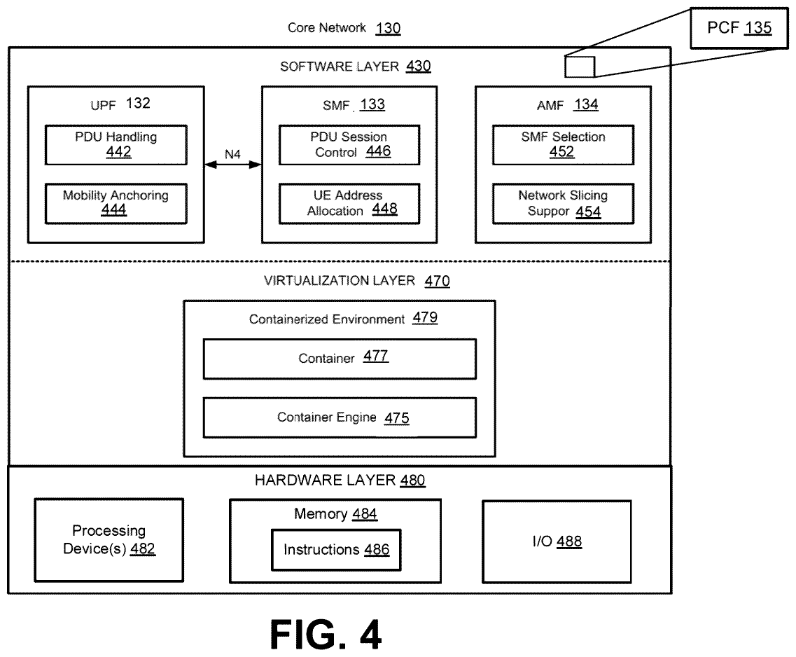

At operation 330, the processing logic determines whether an IMS-undefined RAT type is detected within the UE context stored at the PCF node 135 or 235. As mentioned, one example of an IMS-undefined RAT type includes the NR-REDCAP RAT type. Various methods may be employed to make the determination of operation 330. For example, the processing logic can access a data structure (such as a table) in memory (e.g., the memory 484 of FIG. 4) in which IMS-defined RAT types are listed. Any RAT type not located within the data structure would be an IMS-undefined RAT type. Alternatively, the processing logic can query the A-SBC node 242 whether the multimedia subsystem 240 recognizes the subject RAT type.

If, at operation 330 the RAT type is defined in the multimedia subsystem 240, at operation 360, the processing logic includes the RAT type from the UE context in the media authorization answer 258 to the multimedia sub-system 240.

If, at operation 330 the RAT type is undefined within the multimedia subsystem 240, at operation 340, the processing logic converts the RAT type to a new radio RAT type (or “NR” RAT type).

At operation 350, the processing logic includes the new radio RAT type (“NR”) in the media authorization answer 258 sent to the multimedia subsystem 240 in response to the media authorization request 256. In some embodiments, the multimedia subsystem 240 is an internet protocol (IP) multimedia subsystem (IMS), negotiating establishment of the wireless call session is triggered by a voice over new radio (VoNR) call from the UE, and the media authorization answer 258 is sent to an access session border controller (A-SBC) node or a proxy call session control function (P-CSCF) node of the IMS. For example, the processing logic can trigger the negotiating establishment of the wireless call session in response to receipt of a voice over new radio (VoNR) call from the UE and send the media authorization answer to an access session border controller (A-SBC) node of the IMS.

In some embodiments, the wireless core network 130 is a 4G core network, and receiving the media authorization request 256 and sending the media authorization answer 258 is performed over a receiving (RX) interface of the PCF node 135 or 235. In embodiments, the media authorization request 256 is a diameter authentication and authorization request with an attribute value pair (AVP) of an internet protocol (IP) connectivity access network type.

In other embodiments, the wireless core network 130 is a 5G core network, and the receiving the media authorization request 256 and sending the media authorization answer 258 is performed over an N5 interface of the 5G core network, e.g., which is also an interface with the PCF node 135 or 235. In some embodiments, the media authorization request 256 is a network PCF authorization notify service operation packet.

FIG. 3B is a flow diagram of a method 300B for handling an IMS-undefined RAT type over an Rx (or N5) interface of the PCF node according to additional embodiments. The method 300B may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 300B is performed by the core network 130 FIGS. 1A-2B. In various embodiments, the method 300B is performed by the PCF node 135 or 235. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

At operation 310, the processing logic (e.g., of the PCF node 135 or 325) negotiates establishment of a wireless call session between the UE 208 and the multimedia subsystem 240. In some embodiments, a RAT type is a NR-REDCAP RAT type that is undefined within the multimedia subsystem 240 (or IMS). In other embodiments, the RAT type is non-terrestrial network (NTN RATs), 5G NR unlicensed spectrum (NR-U), private 5G/non-public network (NPN) access, or interworking access types (e.g., Wi-Fi-5G convergence), which may also not be defined within or recognized by the multimedia subsystem 240.

In embodiments, before negotiating establishment of the wireless call session, the 5G core network establishes a PDU session for the UE, which can itself include receiving, from an SMF node, a RAT type (such as NR-REDCAP or other RAT type not recognized by the multimedia system 240) during session setup. The processing logic can store the RAT type of NR-REDCAP within the PCF node 135 or 235. Then, during setting up the wireless call (or SIP) session, the processing logic can retrieve, in response to the media authorization request 256, the RAT type of NR-REDCAP as one of a plurality of parameters of the UE context.

At operation 320, the processing logic receives the media authorization request 256 from the multimedia subsystem 240.

At operation 330, the processing logic determines whether an IMS-undefined RAT type is detected within the UE context stored at the PCF node 135 or 235. As mentioned, one example of an IMS-undefined RAT type includes the NR-REDCAP RAT type. Various methods may be employed to make the determination of operation 330. For example, the processing logic can access a data structure (such as a table) in memory (e.g., the memory 484 of FIG. 4) in which IMS-defined RAT types are listed. Any RAT type not located within the data structure would be an IMS-undefined RAT type. Alternatively, the processing logic can query the A-SBC node 242 whether the multimedia subsystem 240 recognizes the subject RAT type.

If, at operation 330 the RAT type is defined, at operation 360, the processing logic includes the RAT type from the UE context in the media authorization answer 258 to the multimedia sub-system 240.

If, at operation 330 the RAT type is undefined within the multimedia subsystem 240, at operation 370, the processing logic removes the RAT type from the media authorization answer 258 (or otherwise suppressed identification of the RAT type within the media authorization answer 258). For example, in embodiments, removing or suppressing the RAT type from the media authorization answer 258 includes excluding a RAT type value from a RAT type field of the media authorization answer 258.

At operation 380, the processing sends the media authorization answer (without the optional RAT type) to the multimedia subsystem 240 in response to the media authorization request 256. In some embodiments, multimedia subsystem 240 is an internet protocol (IP) multimedia subsystem (IMS), negotiating establishment of the wireless call session is triggered by a voice over new radio (VoNR) call from the UE, and the media authorization answer 258 is sent to an access session border controller (A-SBC) node or a proxy call session control function (P-CSCF) node of the IMS. For example, the processing logic can trigger the negotiating establishment of the wireless call session in response to receipt of a voice over new radio (VoNR) call from the UE and send the media authorization answer to an access session border controller (A-SBC) node of the IMS.

In some embodiments, the wireless core network 130 is a 4G core network, and receiving the media authorization request 256 and sending the media authorization answer 258 is performed over a receiving (RX) interface of the PCF node 135 or 235. In embodiments, the media authorization request 256 is a diameter authentication and authorization request with an attribute value pair (AVP) of an internet protocol (IP) connectivity access network type.

In other embodiments, the wireless core network 130 is a 5G core network, and the receiving the media authorization request 256 and sending the media authorization answer 258 is performed over an N5 interface of the 5G core network, e.g., which is also an interface with the PCF node 135 or 235. In some embodiments, the media authorization request 256 is a network PCF authorization notify service operation packet.

FIG. 4 is a block diagram of some software functionality of the core network 130 according to various aspects of the present disclosure. As depicted, the core network 130 includes a software layer 430 for implementation of core network functions UPF 132, SMF 133, AMF 134, and PCF 135, the latter of which can also be PCF 235. The core network 130 may be used to provide Internet access for user equipment via a radio access network, such as the RAN 120. The AMF 134 may be configured to host various functions including SMF selection 552 and network slicing support 554. The UPF 132 may be configured to host various functions including mobility anchoring 544, PDU handling 542, and QoS handling for the user plane. The SMF 133 may be configured to host various functions including UE IP address allocation and management 548, selection and control of user plane functions, and PDU session control 546. The PCF 135 and 235 may be configured to provide control-plane network function responsible for making policy decisions related to QoS, access control, charging, mobility, and session management.

The core network functions may, in some embodiments, be run by a virtualization layer 470 using containers within a containerized environment 479 that includes a container engine 475 for instantiating and managing application containers, such as container 477. In some embodiments, the containerized environment 479 is executed or generated using a set of machines or may be executed or generated using hardware-level components.

For example, the virtualization layer 470 and/or the software layer 430 may run on a hardware layer 480 that includes one or more processing devices 482, memory 484, and input/output (I/O) 488 hardware and devices. The memory 484 can be volatile memory, non-volatile memory, or a combination thereof. The memory 484 can be memory communicatively coupled with and readable by the one or more processing devices 482 and having stored therein processor-readable instructions which, when executed by the one or more processing devices, cause the one or more processing devices 482 to perform operations disclosed herein.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A computing system to execute at least a portion of a wireless core network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
negotiating, by a policy control function (PCF) node, establishment of a wireless call session between a user equipment (UE) and a multimedia subsystem;
receiving, by the PCF node, a media authorization request from the multimedia subsystem; and
in response to detecting, by the PCF node within a UE context, that a radio access technology (RAT) type is undefined within the multimedia subsystem:
converting the RAT type to a new radio RAT type; and
including the new radio RAT type in a media authorization answer sent to the multimedia subsystem in response to the media authorization request.

2. The computing system of claim 1, wherein the multimedia subsystem is an internet protocol (IP) multimedia subsystem (IMS), negotiating establishment of the wireless call session is triggered by a voice over new radio (VoNR) call from the UE, and wherein the media authorization answer is sent to a proxy call session control function (P-CSCF) node of the IMS.

3. The computing system of claim 2, wherein the wireless call session an IMS session initiation protocol (SIP) session, and wherein the operations further comprise:
during setup of an IMS protocol data unit (PDU) session:
receiving, from a session management function (SMF) node, the RAT type that is undefined within the IMS; and
storing the RAT type within the PCF node; and
during the negotiating establishment of an IMS session initiation protocol (SIP) session, retrieving, in response to the media authorization request, the RAT type as one of a plurality of parameters of the UE context.

4. The computing system of claim 1, wherein the wireless core network is a fourth generation (4G) core network, and wherein the receiving the media authorization request and sending the media authorization answer is performed over a receiving (RX) interface of the PCF node.

5. The computing system of claim 1, wherein the media authorization request is a diameter authentication and authorization request with an attribute value pair of an internet protocol (IP) connectivity access network type.

6. The computing system of claim 1, wherein the wireless core network is a fifth generation (5G) core network, and wherein the receiving the media authorization request and sending the media authorization answer is performed over an N5 interface of the 5G core network.

7. The computing system of claim 1, wherein the media authorization request is a network PCF authorization notify service operation packet.

8. A computing system to execute at least a portion of a wireless core network, the computing system comprising:
one or more processing devices; and
memory communicatively coupled with and readable by the one or more processing devices and having stored therein processor-readable instructions which, when executed by the one or more processing devices, cause the one or more processing devices to perform operations comprising:
negotiating, by a policy control function (PCF) node, establishment of a wireless call session between a user equipment (UE) and a multimedia subsystem;
receiving, by the PCF node, a media authorization request from the multimedia subsystem; and
in response to detecting, by the PCF node within a UE context, that a radio access technology (RAT) is undefined within the multimedia subsystem:
removing the RAT type from a media authorization answer; and
sending the media authorization answer to the multimedia subsystem in response to the media authorization request.

9. The computing system of claim 8, wherein removing the RAT type from the media authorization answer comprises excluding a RAT type value from a RAT type field of the media authorization answer.

10. The computing system of claim 8, wherein the multimedia subsystem is an internet protocol (IP) multimedia subsystem (IMS), negotiating establishment of the wireless call session is triggered by a voice over new radio (VoNR) call from the UE, and wherein the media authorization answer is sent to a proxy call session control function (P-CSCF) node of the IMS.

11. The computing system of claim 10, wherein the wireless call session an IMS session initiation protocol (SIP) session, and wherein the operations further comprise:
during setup of an IMS protocol data unit (PDU) session:
receiving, from a session management function (SMF) node, the RAT type that is undefined within the IMS; and
storing the RAT type within the PCF node; and
during the negotiating establishment of an IMS session initiation protocol (SIP) session, retrieving, in response to the media authorization request, the RAT type as one of a plurality of parameters of the UE context.

12. The computing system of claim 8, wherein the wireless core network is a fourth generation (4G) core network, the receiving the media authorization request and sending the media authorization answer is performed over a receiving (RX) interface of the PCF node, and wherein the media authorization request is a diameter authentication and authorization request with an attribute value pair of an internet protocol (IP) connectivity access network type.

13. The computing system of claim 8, wherein the wireless core network is a fifth generation (5G) core network, the receiving the media authorization request and sending the media authorization answer is performed over an N5 interface, and wherein the media authorization request is a network PCF authorization notify service operation packet.

14. A method operating a computing device for executing at least a portion of a wireless core network, the method comprising:
negotiating, by a policy control function (PCF) node, establishment of a wireless call session between a user equipment (UE) and a multimedia subsystem;
receiving, by the PCF node, a media authorization request from the multimedia subsystem; and
in response to detecting, by the PCF node within a UE context, that a radio access technology (RAT) is undefined within the multimedia subsystem, one of:
including a new radio RAT type in a media authorization answer sent to the multimedia subsystem in response to the media authorization request; or
removing a RAT type value from the media authorization answer sent to the multimedia subsystem in response to the media authorization request.

15. The method of claim 14, wherein the undefined RAT type is a new radio, reduced capability (NR-REDCAP) RAT type, further comprising, for including the new radio RAT type in the media authorization answer, converting the NR-REDCAP RAT type to the new radio RAT type.

16. The method of claim 14, wherein the undefined RAT type is a new radio, reduced capability (NR-REDCAP) RAT type, and wherein removing the RAT type from the media authorization answer comprises excluding a RAT type value from a RAT type field of the media authorization answer.

17. The method of claim 14, wherein the multimedia subsystem is an internet protocol (IP) multimedia subsystem (IMS), the method further comprising:
triggering the negotiating establishment of the wireless call session in response to receipt of a voice over new radio (VoNR) call from the UE; and
sending the media authorization answer to an access session border controller (A-SBC) node of the IMS.

18. The method of claim 17, wherein the wireless call session an IMS session initiation protocol (SIP) session, further comprising:
during setup of an IMS protocol data unit (PDU) session:
receiving, from a session management function (SMF) node, the RAT type that is undefined within the IMS; and
storing the RAT type within the PCF node; and
during the negotiating establishment of an IMS session initiation protocol (SIP) session, retrieving, in response to the media authorization request, the RAT type as one of a plurality of parameters of the UE context.

19. The method of claim 14, wherein the wireless core network is a fourth generation (4G) core network, the receiving the media authorization request and sending the media authorization answer is performed over a receiving (RX) interface of the PCF node, and wherein the media authorization request is a diameter authentication and authorization request with an attribute value pair of an internet protocol (IP) connectivity access network type.

20. The method of claim 14, wherein the wireless core network is a fifth generation (5G) core network, and the receiving the media authorization request and sending the media authorization answer is performed over an N5 interface of the 5G core network, and wherein the media authorization request is a network PCF authorization notify service operation packet.
